(19) United States
(12) Patent Application Publication
(10) Pub. No.: US 2024/0117095 A1
(43) Pub. Date: Apr. 11, 2024

(54) GRIN LENSES MADE BY 3D PRINTING MONOMER-BASED INKS

(71) Applicant: Vadient Optics, LLC, Tualatin, OR (US)

(72) Inventors: Edward Whitney Elliott, III, Eugene, OR (US); Sergiu Coporan, Giurgiu (RO); Patrick Haben, Eugene, OR (US); Alec Gosiak, Eugene, OR (US); Sangyup Song, Eugene, OR (US); Robol Lenorage Chamika Lenora, Chandler, AZ (US); George Williams, Vashon, WA (US)

(21) Appl. No.: 18/469,455

(22) Filed: Sep. 18, 2023

Related U.S. Application Data
(60) Provisional application No. 63/376,584, filed on Sep. 21, 2022.

(51) Int. Cl. C08F 222/10; B29C 64/106; B33Y 10/00; B33Y 70/00; C08K 3/22; C09D 11/30

(52) U.S. Cl. CPC C08F 222/10; B29C 64/106; B33Y 10/00; B33Y 70/00; C08K 3/22; C09D 11/30

(57) ABSTRACT

A curable, optical ink comprises first and second monomer monomers. The first monomer is photopolymerizable over a first wavelength band. The multifunctional second monomer is photopolymerizable over a second wavelength band, which is distinct from the first wavelength band.

### CROSS REFERENCE TO RELATED APPLICATION

This application claims priority to U.S. Provisional Patent Application Ser. No. 63/376,584, filed Sep. 21, 2022, the entirety of which is hereby incorporated herein by reference for all purposes.

### TECHNICAL FIELD OF THE DISCLOSURE

The present disclosure relates generally to optical ink compounds. More specifically, it relates to inkjet-printable optical ink compositions suitable for 3D printing of gradient refractive index (GRIN) optical components.

### BRIEF DESCRIPTION OF THE DRAWINGS

The accompanying drawings, which are incorporated in and constitute a part of the specification, schematically illustrate embodiments of the present disclosure, and together with the general description given above and the detailed description of referred methods and embodiment given below, serve to explain principles of the present disclosure.

FIG. 1A is a schematic of an example optical ink matrix.

FIG. 1B is a schematic of an example multifunctional monomer used in an optical ink.

FIGS. 2A and 2B show exemplary embodiments of molecular structures of multifunctional monomers used in an optical ink.

FIG. 2C shows exemplary embodiments of molecular structures of a high refractive index multifunctional monomer used in an optical ink.

FIG. 2D illustrates various zones of fluidic properties relevant to ink printing, on a theoretic plot of Ohnesorge number versus Reynolds number.

FIG. 2E shows on the left side certain relationships among fluidic metrics relevant to ink printing, and, on the right side a plot of the Weber number plotted against the inverse of the Ohnesorge number.

FIG. 2F is a plot of a larger multi-dimensional operating space defined by dimensionless groups for dispersing complex optical inks under different print conditions.

FIG. 3 shows a flowchart of an example method of making a GRIN lens comprising multifunctional monomers used in an optical ink.

FIG. 4A is a collection of plots of the refractive index (RI) as a function of wavelength for three optical inks a relatively high refractive index and two optical inks of relatively low refractive index.

FIG. 4B is a plot of the refractive index of example inks plotted against corresponding dispersion values.

FIG. 4C is a plot of the refractive index of example inks plotted against corresponding dispersion and partial dispersion values, in a three-axis representation.

FIG. 5 shows a flowchart of an example method of making a GRIN lens comprising a mono-functional monomer used in an optical ink.

### DETAILED DESCRIPTION

One major advantage to the 3D printing approach is the ability to fabricate gradient-index (GRIN) optics. GRIN optics is the branch of optics covering optical effects produced by a gradient of the refractive index of a material, although, more generally, any of the complex dielectric properties of the material, including permeability, permittivity, or nonlinear properties, can be varied, allowing for manipulation of electro-magnetic radiation in the visible, infrared, microwave, and millimeter wavelength regions. Variations in the refractive index can be used to produce optical devices with flat surfaces that do not have the aberrations typical of traditional surface figured lenses made of homogeneous glass or plastic materials.

The function of a spherical lens is to produce a radially varying delay of the optical phase of a beam; the resulting wavefront curvature can make a beam converging or diverging after the lens. The ratio between the speed of light c and the phase velocity νₚ is known as the refractive index. The real part of the refractive index (n) of a material is a measure of how much slower light travels in that material compared to its speed in vacuum. Different materials have different refractive indices due to their unique interactions with light waves. When light travels from a high refractive index material to a low refractive index material, or vice versa, several optical phenomena occur due to the change in the speed of light and the bending (refraction) that occurs at the interface between the two materials. If light enters a material with a higher refractive index, it bends toward the normal (a line perpendicular to the interface). If it enters a material with a lower refractive index, it bends away from the normal. When light travels from a high refractive index material to a low refractive index material (or vice versa), it experiences a change in phase velocity due to the change in refractive index. This change in phase velocity can lead to a phenomenon known as phase delay. In the high refractive index material, the speed of light is lower, while in a low refractive index material, it's higher. This speed change is responsible for the bending of light and the subsequent change in direction.

Lenses and optical elements take advantage of the bending of light at interfaces to focus or defocus light rays. In ordinary lenses, the element is made of a material that is homogeneous, with a constant n throughout the bulk of the element. In ordinary lenses, the radially varying phase delay is produced by using a surface figure to vary the thickness of the lens material. When light waves encounter the curved surface, the curvature of the lens surface causes the light waves to change direction according to the laws of refraction. In a GRIN lens, the thickness may be constant (i.e., a plano-plano configuration) and when n varies in the radial direction from a high index value in the center of the optical element to a lowest index value at the edge of the optical element, the index gradient across the optical element causes an accumulation of phase differences that leads to a phase delay cross the wavefront that causes the light to focus. Gradient-index optical elements may have index gradients that vary in one, two, or three dimensions. The gradient index profiles may be freeform, with no axes of symmetry. The gradient profiles may also have one or more axes of symmetry. For example, the index gradient may vary axially.

For on-axis optical systems, radial coordinates are often used to describe GRIN optical devices. In such systems, the gradient profiles may vary axially, radially, or both axially and radially. In a radially symmetrical GRIN element, the n values created by the inks may be used to produce gradients that vary with the radius, r, of the lens. The index gradients may vary as a function of one or more radial powers, r\hat{ }x, with x taking on even values like 2, 4, 6, and so on. The radial distributions may be constant or vary along the axial direction, z. Non radially symmetric GRIN elements may include both even and odd radial distributions that may also change as a function of the angle, 0, about the optical axis. The ability to arbitrarily vary the RI in the x, y and z directions broadens the configuration space of optical components. Alternative coordinate systems also may be used to represent the GRIN distributions.

It is also possible to make hybrid lenses that combine both operation principles, i.e., to implement curved surfaces on GRIN optical, wherein phase delay is introduced both by surface figure and by index gradients. For example, in these devices, optical power may be primary achieved by phase delays created by the optical surface, and geometric aberrations may be compensated by phase delays implemented in the gradient index profiles. By changing the refractive index spectra, n(λ), of the materials used to construct the gradient index devices, it is possible to create index gradients that vary as a function of wavelength. This makes it possible to create gradients with independent control over chromatic dispersion and to correct for chromatic aberrations.

It is challenging to balance the optical requirements of the printed inks with the rheological requirements of 3D inkjet printing, such that the optical materials may be stable and reliability printed, mixed, and cured, as well as for the physical properties such as hardness, strength, and environmental robustness to be achieved. In particular, it is often desirable to add dopants or fillers (collectively referred to as “additives”) to the optical inks in order for desired properties to be achieved. However, the addition of additives to the host matrix material often greatly increases viscosity and density, impairing the ability to inkjet print the resulting materials. As a result, for example, there is often a limit to the practical range of printable refractive index values that may be obtained using the aforementioned composite materials.

To make inkjet printable GRIN lenses, at minimum an optical ink pair is required. The optical ink pair may include a high RI material and a low RI material pair, from which an index gradient can be created. The continuum of intermediate index values between the high RI and low RI values are created using different mixes of the high RI and the low RI materials. At any wavelength, the differences between the highest and the lowest RI values of an ink pair is known as Δn(λ), which at a single reference wavelength, λ_{c}, in the center of the range of wavelengths is referenced as Δn. The key point is that the inks operate as a ‘low-high’ RI pair that can be used to create index gradients that produce optical power, or otherwise cause phase delays that can be used to alter the optical path, at one or more wavelengths.

The Δn is proportional to the optical power of the lens. For example, for a fixed magnification, by increasing Δn, thinner lenses can be made, or conversely, for lenses of a fixed thickness, greater magnification can be realized with a larger Δn. In other cases, Δn is used both to achieve optical power and to correct for aberrations. The method used to create the index gradients from a ‘low-high’ RI pair is conceptually similar to that of ‘halftoning’ used in black and white graphics printing, whereby different densities of black values are used, on white backgrounds, to create greyscale images. In the case of printed GRIN materials, the resulting RI value is caused by mixes of the two materials n=x*n(high)+(1−x)*n(low), where x is the relative composition between 0 and 1, n(high) is the RI of the high index material, and n(low) is the RI of the low index material.

Halftoning gradient index profiles involves converting continuous tone profiles into patterns of deposited droplets or discrete tones to achieve, after interdiffusion, smooth gradient index profiles. When more than two materials are used, “multi-toning” processes are used. Several methods may be used to multi-tone the gradient profiles, such that they may be printed with a limited number of inks, including error diffusion, ordered dithering, stochastic screening, or hybrid methods that use one of more of these methods, or others, in combination.

Error diffusion is a technique that may be employed for halftoning to reproduce continuous tone RI profiles using only a limited set of optical inks. In the context of halftoning a gradient index profile for printing, error diffusion distributes quantization errors generated during the conversion of continuous RI values into discrete tones across neighboring pixels in a systematic manner. This diffusion process minimizes visual artifacts and maintains the perceived quality of the original image while utilizing a restricted palette of printing tones. By iteratively propagating these errors, the technique achieves a perceptually accurate representation of the gradient index profile, allowing it to be accurately reproduced in the printed output. It is also possible to create RI gradients from ternary, quaternary, or larger optical ink mixes. For example, a three optical inks set may be configured using a high RI material, n(high), a low RI material, n(low), and an intermediate RI, n(int) optical ink, wherein n(int) may be selected to fall between n(high) and n(low).

Generally, printing using more than two inks, including the use of inks with intermediate RI values, allows for more control over the GRIN profile accuracy, as quantization errors are reduced. The RI is generally defined at a center wavelength, λ_{c}, as is the Δn of an optical ink pair. However, the RI varies over a wavelength range, λₛₕₒᵣₜ-λ_{long}, where λₛₕₒᵣₜ<λ_{c}<λ_{long}, as a result Δn may vary over the wavelength range. By changing the value of Δn as a function of wavelength it is possible to control the primary, secondary, and higher order color properties of a GRIN optical device. This allows for correction for primary and partial dispersion introduced earlier in the optical stack, at the surface of the optical device, or within the optical device.

Introducing three or more optical inks allows optical devices to be constructed, with index gradients that have a broad range of dispersion and partial dispersion values. Using three or more materials makes it possible to create index gradients with independent control over dispersion. The RI slopes of the inks may vary controllably, such that Δn varies as a function of wavelength. By controlling RI(λ), it is possible to cause Δn values to increase or decrease in magnitude with respect to wavelength. In this way, optical power can be made to be larger or smaller in the short wavelengths, compared to the optical power in the longer wavelengths. In this way the dispersion and partial dispersion may be locally controlled throughout the of the optical device.

At the short wavelength, the different in index values is Δn(λₛₕₒᵣₜ) and long wavelength, the index value is Δn(λ_{long}). If Δn(λₛₕₒᵣₜ)>Δn(λ_{long}), the optical power is greater at λₛₕₒᵣₜ than it is at λ_{long}. This causes light with wavelength λₛₕₒᵣₜ to focus a shorter distance than light with wavelength λ_{long}. When Δn(λ_{long})>Δn(λₛₕₒᵣₜ) then the optical power is greater at λ_{long} than it is at λₛₕₒᵣₜ, causing light with wavelength λ_{long} to focus a shorter distance than light with wavelength λₛₕₒᵣₜ.

An “achromatic” system is one that is constructed or corrected in a way that reduces or eliminates chromatic aberration. An achromatic system corrects for two primary colors, usually blue and red (i.e., short and long). It brings these two wavelengths to a common focal point. This correction helps reduce color fringing and improves image quality. An apochromatic system goes a step further in chromatic aberration correction. It corrects for three primary colors: blue, green, and red. This more advanced correction aims to bring these three wavelengths to a common focal point.

In conventional optical systems, achromatic lenses are constructed using a combination of different lens materials with specific dispersion properties to counteract the color separation. Using surface figured homogeneous index lenses, this is typically achieved through a combination of lenses made from different materials with different dispersion properties. Apochromatic lenses use even more complex designs and combinations of lens materials to achieve this higher level of chromatic correction.

In a plane parallel GRIN optical device, wherein the front and back surfaces of the optical are flat, it is possible to cause the short and long wavelength light to focus at a common point, if Δn(λ_{long})=Δn(λₛₕₒᵣₜ), such that the phase delay experienced by light is the same for each wavelength. This may be achieved if [n_{λshort}(high)−n_{λshort}(low)]=[n_{λshort}(low)−n_{λshort}(low)], which means that the slope of the refractive index spectra of the high and the low index is the same (the primary slopes of the refractive index spectra are parallel).

For a non-plane parallel optical device, achromatic performance may be obtained by mixing three or more optical inks, such that different mixes of optical inks may be deposited to create multiple gradients within the device, each with a specific dispersion and partial dispersion profile and accumulates phase delays specific to different wavelength regimes. In other optical configurations, such as for a spectrometer, it is may be desirable that the index remain uniform throughout the device, wherein Δn=0, such that multiple inks with complementary refractive index spectra, with different dispersion and partial dispersion, may be patterned to mix in different ratios to cause light to spatially disperse as a function of wavelength. Accordingly, the range of RI values and the range of the refractive index spectra must be controlled over a wide range using different inks. However, this approach introduces challenges in the materials' miscibility or may introduce challenges in other print property compatibility. For example, after inkjet print deposition, the different properties of the monomers may result in material separation, irregular mixing, or inter-diffusion of the materials prior to curing.

This disclosure provides a tailorable route to generating a complementary GRIN ink set, including low and high RI inks, intermediate RI inks, and inks with specific refractive index spectra, wherein each ink component has a specific role. Because the role of each component is well-known, issues with formulation stability, cure hardness, optical power, poor inkjet firing, etc., can be addressed. In combination, the low and high RI ink pair families may enable a maximum gradient value of Δn>0.35 at the center wavelength, λ_{c}, and the chromatic properties of the inks may be controlled independently, which would represent a significant advancement from current technology.

The present disclosure is directed to optical inks suitable for 3D printing fabrication of (GRIN) optical components. Developing GRIN inks for drop-on-demand inkjet printing is challenging. Generally, for creating lenses with optical power, inks are matched in sets, with a set containing of high refractive index (RI) and a low RI inks with different dispersion characteristics. One property of the individual inks is that they have a desired RI at a center wavelength, λc, or otherwise designate wavelength. The difference in index values between two inks with different RI values is known as Δn and is generally defined near the center of a wavelength range, or as otherwise specified. The Δn value defines the range of optical path distance delays that can be introduced into the GRIN device and, among other properties, may be proportional to the optical power of the lens. This means, for example, that for a fixed magnification, by increasing Δn, thinner lenses can be made, or conversely, by increasing Δn greater magnification can be realized with a single element thickness. Gradients created from the intermediate RI values of a Δn value may also be used to correct for geometric aberrations.

Additionally, inks with different chromatic properties are beneficial. Each ink may be composed to have specific RI properties that differ for over a range of wavelengths. In these inks, the RI values, hence Δn, are defined as a function of wavelength, specified as Δn_{λ}. To obtain well-defined refractive index spectra, the inks generally are composed of three or more constituents (monomers, additives, nanoparticles, etc.). Additionally, additives may be used to increase the hardness, strength, and environmental stability of optics. Increasing the number of additives places demands on the ink composition. The inks should be stable, such that the constituents do not agglomerate as they are composed, stored, printed, and cured. Large agglomerations, with dimensions larger than about 1/20 the wavelength of the light, may scatter light in the optical element. Further, the ink should possess the rheological characteristics that will facilitate jetting the ink with readily available printheads onto desired substrates.

The formulation space for inkjet inks is very restricted, thanks to the combination of the dimensionless Ohnesorge, Weber, and Reynolds numbers. Optimizing inkjet printing requires careful tuning of both the ink's properties (like viscosity, surface tension, and density) and the printing conditions (like jetting velocity and nozzle diameter) relative to the substrate conditions (like the wetting angle, surface roughness, and surface energy). By controlling these factors, one can adjust the Ohnesorge, Reynolds and Weber numbers to achieve consistent, stable droplet formation and deposition.

There are a number of factors that influence the drop formation such as the fluid/air surface tension barrier near the nozzle. For the ejection of the drop it should have a minimum velocity to overcome the barrier. The minimum velocity, υₘᵢₙ, is generally given by: υₘᵢₙ=[(4γ)/(ρd)], where d is the nozzle diameter and γ is the surface tension. After the drop appears outside of the nozzle during the time of printing, the speed of the drop head is relatively high, and it slows down with time due to the formation of a long tail behind the drop. The length of the tail will be long when the drop speed is more than the speed of the tail. This is the case when the viscosity of the ink is high. The higher speed of the drop head with respect to the tail causes the breakdown of the tail into small fractions and it forms satellite droplets. Viscosity is a parameter that controls the shape of the tail that is formed during printing. A highly viscous ink shows a long symmetric tail shape, and the length and symmetry of the tail decrease with the decrease of viscosity.

The Weber number (We) is a dimensionless number used in fluid mechanics that describes the relative importance of the fluid's inertia compared to its surface tension. It's particularly useful in analyzing phenomena where there are rapid surface shape changes, such as droplet formation or the breakup of fluid jets. The Weber number (We) is defined as: We=ρV²L/σ, where ρ is the fluid density (kg/m³), V is a characteristic velocity (m/s), L is a characteristic length (m), σ is the surface tension of the fluid (N/m or kg/s²). When analyzing droplets, the characteristic velocity could be the speed of the droplet, and the characteristic length might be the diameter of the droplet. In contexts where the Weber number is high, inertial effects dominate over surface tension effects. Conversely, when the Weber number is low, surface tension effects are more significant compared to inertial effects. The Weber number relates inertial forces to surface tension forces. It plays a role in phenomena involving droplet breakup or splashing upon impact. A high Weber numbers suggest that the fluid's inertia can overcome its surface tension, causing a droplet to break up. However, if the We is too high, droplets might break up prematurely or inconsistently, leading to variable droplet sizes.

Satellite droplets are smaller droplets that form between main droplets. The Weber number influences the formation of these satellites. If the We is not optimized (often if it's too high), more satellite droplets may form, leading to print artifacts and reduced print quality. After ejection, when droplets land on a substrate, their spreading and penetration behaviors are also influenced by the We. A high We can lead to more significant droplet splatter and spreading due to the higher kinetic energy of the droplet, impacting print resolution and edge definition. The Reynolds number (Re) is a dimensionless quantity used in fluid mechanics to predict flow patterns in different fluid flow situations. It describes the ratio of inertial forces to viscous forces and characterizes the flow regime as either laminar, turbulent, or transitional. The Reynolds number is defined as: Re=ρVL/μ, or Re=VL/υ, where: ρ is the fluid density (kg/m³), V is the characteristic flow velocity (m/s), L is a characteristic length scale (often diameter for pipes) (m), μ is the dynamic viscosity of the fluid (Pa·s or kg/(m·s)), ν is the kinematic viscosity is defined a ν=μ/ρ (m\hat{ }2/s).

The Reynolds number serves as a criterion to determine the type of flow. The Reynolds number helps in determining whether the ink flow inside the nozzle is laminar or turbulent. For low Reynolds numbers, viscous forces dominate, resulting in laminar flow, while at high Reynolds numbers, inertial forces dominate, leading to turbulence. A laminar flow (low Re) ensures consistent droplet formation, while turbulent flow (high Re) can lead to irregular droplet sizes and satellite droplet formation. For most inkjet printing systems, the flow inside the nozzle is typically laminar to ensure consistent droplet formation. The Reynolds number, along with other factors, affects how the ink jet breaks up into individual droplets after emerging from the nozzle. In certain configurations, a higher Re can accelerate jet instability, leading to earlier droplet breakup.

The Ohnesorge Number (Oh) is a dimensionless number that relates the viscous forces, inertial forces, and surface tension forces. It's particularly relevant in droplet formation and ejection from nozzles. For printheads, ensuring that the Ohnesorge number is within an optimal range can help in achieving stable droplet generation. The Ohnesorge number describes the tendency for a drop to either stay together or fly apart, by comparing viscous forces with inertial and surface tension forces. The Ohnesorge number may be written in terms of the square root of the Weber number divided by the Reynolds number. It is defined as Oh=μ/(sqrt(ρσL)=sqrt(We)/Re.

For a simple Newtonian fluid where the viscosity is independent of the shear rate and there is no elasticity, the Ohnesorge number can be used to determine a range in which printing is possible. If the Oh number is too large (>1), the fluid is so viscous that there is not sufficient energy to form a jet and that if the Oh number is too small (<01), surface tension will induce satellite drop formation. While calculating the Oh number may be useful, the prediction of the printable region is based on a simple Newtonian fluid.

In some cases, the inverse of the Ohnesorge number, Z, can be more relevant than the Ohnesorge number for relating the relates the effect of viscosity and surface tension on droplet formation. The Z-number is defined as Z=sqrt [(ρσL)/μ\hat{ }2/]=1/Oh. While calculating the Oh number may be useful, its prediction of the printable region is based on a simple Newtonian fluid. However, nanocomposites often are better described by more complex viscoelastic behavior. Viscoelastic fluids have both viscous and elastic properties. This means their viscosity can change with shear rate, and they can also exhibit elastic deformation (ability to recover their shape after deformation).

If solvents are used as the nanocomposite ink is printed and the solvent evaporates, the ink's viscosity and behavior can change. Due to the challenges of completely removing solvents and the challenges of controlling shrinkage during drying, it is often desirable to optimize the viscosity of the inks without the use of solvents. However, solvent-free inks or materials might have higher viscosities, especially when loaded with nanoparticle additives, making them harder to optimize for the printing technologies. Formulating solvent-free inks can be more complex, requiring careful consideration of rheology, particle dispersion, and compatibility.

Nanoparticle additives can significantly affect the rheology of the droplet. Higher densities of nanoparticles generally increase viscosity, which can slow down the droplet spreading. Depending on the type and interaction of the nanoparticles with the monomer, the droplet might also exhibit non-Newtonian or even viscoelastic behaviors. The jet breakup and drop formation during inkjet printing depends on the interplay between inertial, viscous, elastic and surface forces.

Additional dimensionless groups, such as the Weissenberg (Wi) number, the ratio between the characteristic relaxation time of the fluid and deformation rate, Wᵢ=V/D, and the Deborah (De) number, De=λ/sqrt(ρR\hat{ }3/σ), are needed for describing the behavior of viscoelastic fluids. The product of Wi and De numbers result in a dimensionless “Elasticity number” (EI), El=Wi/Re=ηλ/(ρD²), which describes the relative importance of the inertia and elastic stresses. Note, that ρ is the density, n is the viscosity, σ is the surface tension and λ is the characteristic time of the fluid, whereas D is the characteristic length (usually the nozzle diameter) and V is the velocity of the jet.

Among the key characteristics defined in these dimensionless numbers are viscosity, density, and surface tension. Note that surface tension is important because the surface tensions should be matched between deposited ink sets to facilitate drop placement accuracy. Surface tension can be thought of as the force that ‘holds’ a fluid together in the presence of air, within its own confines—the tangential intermolecular force of attraction between adjacent molecules. Surface tension is expressed as force per unit of width, as dynes/cm (or mN/m). If ink surface tensions are not matched, after deposition, the ink drops can unpredictably move on the substrate, causing deviations in the GRIN patterns from those intended.

To create accurate gradient RI profiles using only a few (e.g., a pair) of inks it is advantageous to predictably cause the inks to precisely mix, or inter-diffuse in a reproducible manner. When the nanocomposite droplets with various types and densities of nanoparticles embedded in monomer host materials impact a surface near each other and in varying patterns, several characteristics and mechanisms govern the droplet kinetics and the subsequent interdiffusion of their constituents. Upon impact, the droplet can exhibit different wetting behaviors (from complete wetting to partial wetting) which is a function of the droplet's composition and the substrate's properties. After impact, a droplet will typically spread out before recoiling to some extent due to surface tension. This behavior can be influenced by the viscosity of the monomer and the presence of nanoparticles.

The velocity at which the droplet strikes the surface can determine how much it spreads, whether it rebounds, or even breaks up. The Weber number can determine whether the droplet splashes, spreads out, or recoils. The Reynolds number can inform whether the internal flow within the droplet is laminar or turbulent. The affinity of the monomer and nanoparticles for the substrate can influence their diffusion rates. Monomers will generally start to diffuse into one another when two droplets come into contact. The diffusion rate can be influenced by the molecular weight, size, and chemical nature of the monomer.

Nanoparticles will generally have a much slower diffusion rate compared to the monomers due to their larger size. The propensity of the nanoparticles to agglomerate can hinder their diffusion. However, this can be influenced by the type, size, and surface chemistry of the nanoparticles. If there's a difference in nanoparticle concentration between the droplets, this will drive diffusion due to concentration gradients. If there's a temperature difference between the droplet and the surface, or within the droplet itself due to evaporation or condensation, Marangoni flows can develop. If the monomer is volatile or if other volatile solvents are present, their evaporation can impact the interdiffusion rates and patterns by creating concentration gradients or by inducing Marangoni flows.

When considering temperature-dependent surface tension, a common definition of the Marangoni number is Ma=[ΔT dσ/dT]/μμ, where ΔT is the temperature difference, do/dT is the derivative of surface tension with respect to temperature. Marangoni flows result from gradients in surface tension along an interface. If there's a temperature gradient (or concentration gradient for solutes) at an interface and this gradient leads to a difference in surface tension, this can induce a flow. Marangoni flows can counteract or enhance other convective flows, leading to complex behaviors in droplets and thin films.

UV light, temperature, or other external stimuli can be used to initiate polymerization of the monomer, which will affect the diffusion dynamics. Also, external fields (e.g., electric or magnetic) can influence the distribution and movement of certain nanoparticles. Once the constituents of the inks have inter diffused sufficiently to create the desired multi-wavelength index gradients, they should be should be cured via photonic light exposure (e.g., UV, IR, X-ray, etc.) to form a hardened final optic part. The final cured part should be physically robust and hard enough to be incorporated into an optical system. As needed, final thermal curing can be used to complete the polymerization and harden the optic. Photonic photobleaching may be used to complete curing and remove any photoinitiator. The part optical and physical requirements may vary depending on customer demands. This requires significant flexibility in the ink composition to realize success in satisfying specific requirements.

The solutions herein implement a multi-component ink family architecture that meets the complex requirements of inkjet-printed GRIN optical devices. Each individual ink component is targeted at a specific requirement of the printable optical ink and can be replaced with one of several analogs to tune specific ink characteristics for the desired optical application. Described here is a family of inks, including both high and low RI inks compositions, which have refractive index spectra that may be tailored relative to one another by the introduction of additives.

The optical inks are composed of one (or more) monomer(s), wherein the ink has a viscosity less than 100 cPoise at the temperature of the printhead (e.g., between 20° C. and 120° C.), with a more desirable target property for most common printheads of less than 20 cPoise (less viscosity) at a lower upper temperature range (e.g., less than 80° C.). The inks are printed and photocured to form a solid polymer.

The monomers are selected or configured such that the resulting polymerized material has a crosslink density greater than 1×10⁻⁴ mol/cm³. More generally, any photocurable monomer can be used within the vinyl, acrylate, methacrylate or urethane classes. Example monomers include vinyl, acrylate, methacrylate, epoxide, urethane, ether, ester, acrylate-functionalized epoxide, acrylate-functionalized urethane, acrylate-functionalized ether, acrylate-functionalized ester, methacrylate-functionalized epoxide, methacrylate-functionalized urethane, methacrylate-functionalized ether, and methacrylate-functionalized ester monomers. Two (or more) miscible inks are used to create a compatible ink set wherein the RI is varied over a range where Δn≥0.02 by varying the composition of the monomers, or the ratio of the monomers in the mixture of inks.

In one embodiment, the difference in RI is achieved by using two or more monomers with different refractive indices in each ink, and then varying the ratio of the monomers to create desired RI values over a Δn range. In another embodiment, each ink is composed of a single multifunctional monomer with a different RI. Some embodiments use monomers containing phenyl functionality or hetero atoms such as sulfur (S), or halogens to raise the RI above that which can be achieved by monomers containing only carbon (C), oxygen (O), and hydrogen (H), and monomers containing fluorine (F) to lower the refractive index below that which can be achieved in monomers containing only C, O, and H.

Ideal embodiments for high index optical inks is to use high refractive index monoacrylate based materials [e.g., benzyl acrylate (BA), benzyl methacrylate (BMA), 2-(phenylphenylthio)ethyl acrylate (2-PTEA), benzenethiol methacrylate (BTM)] to raise the baseline refractive index (RI) of the ink formulation. Each of these embodiments may be augmented by organic or inorganic additives, such as nanoparticles to raise, or lower, the RI or to change the RI with respect to wavelength, RI(A), obtain the desired chromatic properties.

The creation of precise three-dimensional optical lenses and other optical structures by stereolithography is known to those skilled in the art of GRIN lens configuration. Embodiments of the present disclosure include optical inks suitable for use in fabricating GRIN lenses using 3D printing technology such as standard drop-on-demand inkjet printing. These inks may also be used to fabricate GRIN lenses using other printing techniques such as screen printing, tampo printing, aerosol jet printing, and laser cure printing.

Embodiments of the present disclosure provide inks suitable for the practical realization of printable inks for high quality GRIN lens fabrication, which provide the ability to control the index of refraction in three dimensions for creating large, localized index changes while maintaining high optical transmission and freedom from deleterious scattering phenomena that arise from feature sizes approaching λ/20, where λ is the lowest wavelength of light that the optical element is intended to be used.

Optical inks prepared according to the embodiments of the present disclosure are composed of monomers or blends of monomers with photoinitiators enabling polymerization by UV (or visible light or other ionizing radiation sources) with rheological properties suitable for 3D additive manufacture. Each of the monomer-based inks are placed in adjacent inkjet printheads. The number of inks, and adjacent printheads, is at least two, and other printheads may be used to incorporate additional inks with different optical properties (e.g., varied RI within a Δn range at a fixed wavelength, achromatic or apochromatic wherein the slope of the RI values is constant over a range of wavelength values, or chromatic dispersions wherein the RI values, hence Δn, varies as a function of wavelength).

Drop-on-demand inkjet printing technology is used to create microscopic features on the sample in order to precisely control the placement of localized gradient refractive index regions, which are controlled by mixing two (or more) high and low refractive index inks. The localized composition is controlled by the placement and number of drops of each ink and the amount of time allowed for diffusion controlled mixing following drop placement before locking the GRIN pattern in place by polymerization.

Rapid diffusion of the monomers of different refractive index spectra, allow for creating smoothing RI gradients, with RI gradient feature irregularities that are a fraction of an optical wavelength (λ/10, λ/20, etc.) in dimension, despite the relatively large size (dimensions greater than the wavelength of light, λ>300 nm) of the deposited drops. Preferably, the diffusion time to obtain smooth refractive index gradient patterns is greater than the time for material deposition. Three-dimensional GRIN patterns are created by depositing and patterning materials, layer by layer. The local volumetric concentration of each of the inks within the optical component determines the local effective refractive index. Differences in the concentrations of each of the ink components cause RI gradients in one or more coordinate directions.

Since drop-on-demand inkjet may utilize multiple printheads with different loading of the index-changing dopant, the inks provided by the present disclosure may be used in various combinations with each other as well as with other optical inks, such as those described in U.S. Patent Application Publication 2018/0022950, which hereby incorporated by herein by reference, for all purposes. This type of embodiment has been demonstrated (in the combination of the fluoroacrylate described with the material described in the reference.

According to embodiments of the present disclosure, an optical ink is composed of a monomer, or mixture of monomers that is polymerizable by photocuring (e.g., by UV, visible, or infrared light or other ionizing radiation) to provide a solid polymer. Preferably, the monomers used are such that UV curing results in a highly crosslinked material. Further, the monomers used in each of the inks used to fabricate the GRIN element are chosen such that shrinking is less than 20% and the relative shrinkage between the various inks is less than 10%, which serves to minimize deformation of the optical structure as well as minimizing stress/strain in the solid part to overcome limits in the dimension of the parts that may be fabricated. The GRIN element, once cured, has a transmittance of at least 80% (preferably >99%) at the wavelengths of interest (e.g., visible spectrum, or infra-red spectrum).

According to embodiments of the present disclosure, each component of the ink may have a specific purpose. For example, high refractive index monoacrylate based materials [e.g., benzyl acrylate (BA), benzyl methacrylate (BMA), 2-(phenylphenylthio)ethyl acrylate (2-PTEA), benzenethiol methacrylate (BTM)] may be used to raise the baseline refractive index (RI) of the ink formulation. According to other embodiments of the present disclosure, low viscosity cross-linking diacrylates [e.g., neopentylglycol diacrylate (NPGDA), diethyleneglycol diacrylate (DEGDA), 1,6-hexanediol diacrylate (HDODA)] may be used to improve cross-linking in the cured polymer. This contributes to a harder final part, without greatly increasing the viscosity of the mixed ink. According to other embodiments of the present disclosure, higher viscosity, cross-linking diacrylate species [e.g., tricyclodecane dimethanol diacrylate (TCMDA)] may be included to dramatically increase the hardness of the final part. The amount included is carefully controlled, however, because the viscosity of this species is high. According to other embodiments of the present disclosure, simple surfactant molecules may also be added to inks to match surface tensions between inks. According to other embodiments of the present disclosure, nanoparticles (e.g., oxide particles) can then be added in varying amounts to achieve the desired RI at one or more wavelengths of light.

Nanoparticles of varying elemental composition may be added to the inks to drastically alter the refractive index of the ink mixture, and also improve the hardness of the final cured part. The nanoparticles may be polymer (PTFE, PC, PMMA, DEGDA, NPGDA, TCMDA, BMA, FEGDA, PE, PS, PP, PMP, PVP, HDMDA, Polydimethylsiloxane, di-acrylates, fluoropolymers, cycloolefin Polymers, cycloolefin Copolymers, etc.), metal oxide (ZnO, SiO₂, ZrO₂, TiO₂, BaTiO₃, Al₂O₃, AZO, VoX, WO₃, Co₃O₄, etc), chalcogenide (Ag₂S, Ag₂Se, Ag₂Te, PbS, PbSe, PbTe, etc.), semiconductor (CdSe, CdTe, CdS, PbS, PbSe, Si, Ge, InAs, etc), carbonaceous (graphene, graphene oxide (GO), carbon quantum dots, graphite, carbon nanotubes (CNT), multi-wall carbon nanotubes (MWCNT), fullerenes, nanodiamonds), ferromagnetic (Fe₃O₄, Fe₂O₃, FeCo, CoFe₂O₄, Mn—Zn Ferrite, Co, Ni, ferrite, hexaferrite, NZFO, etc), metals (Sn, Sb, Pt, Ag, Au, Cu) materials, including hollow-shell, core-only, core-shell, or core-multishell architectures, which can be a specific size and shape, and may incorporating one or more material types.

Preferred embodiments for high RI inks use high index monomers with high RI nanoparticles, such as TiO2 (n=2.4-2.7), ZrO₂ (n=2.0-2.3), BaTiO3 (n=2.3-2.6). Preferred embodiments for low RI inks use high index monomers with low RI nanoparticles, such as silicon hollow nanospheres (SNH; n=1.05-1.15), MgF2 (N=1.37, or polymer nanoparticles (n=1.4-1.7). Each nanoparticle has a specific dispersive slope. To cover the broadest range of applications, it would be desirable to have both high and low RI inks sets with low, medium, and high dispersion. However, generally high RI materials have high dispersion, and low RI materials have low dispersion. Examples of nanoparticle materials with high dispersion include TiO₂ (dn/dλ=0.21); BaTiO₃ (dn/dλ=0.1148), and AZO (dn/dλ=0.1327). Examples of nanoparticle materials with low dispersion include silicon hollow nanospheres (SHN; dn/dλ=0.0023), nanodiamond (dn/dλ=0.0257), SiO₂ (dn/dλ=0.0068), and MgF₂ (dn/dλ=0.0036).

Nevertheless, because the dispersion of GRIN is determined by the dispersive slopes of the high and low RI inks relative to one another, it is possible to create optical ink sets, which have both positive dispersion [Δn(λshort)>Δn(λlong)] and negative dispersion [Δn(λlong)>Δn(λshort)], as well as achromatic ink sets [Δn(λshort)=Δn(λlong)]. For example, when 8.02% TiO2 and 10.98% ZrO2 is mixed with a mix of (40.50% 16.20% 24.30%) the index is n=1.708 dispersive slope is dn/dλ=0.0301. When 19% AZO is mixed with 81% FEGDA, the index is n=1.409 and the dispersive slope is dn/dλ=0.0301. When the two inks are combined, Δn=0.3 and [Δn(λc)/(Δn(λshort)−Δn(λlong))]=∞, which means that the ink pair is achromatic

The Table below shows the index and dispersive slope of five different inks, and shows Δn when they are paired with the others, as well as the differences between their dispersive slopes, and the difference between their partial dispersion values.

| | | | 1 | 2 | 3 | 4 | 5 |
|---|---|---|---|---|---|---|---|
| n | | | Δn | | | | |
| 0% NP/NPGDA | 1.491 | 1 | x | 0.168 | 0.000 | 0.007 | 0.217 |
| 19% ZrO2/MM1 | 1.660 | 2 | −0.168 | x | −0.168 | −0.161 | 0.049 |
| 19% AZO/FEGDA | 1.492 | 3 | 0.000 | 0.168 | x | 0.007 | 0.217 |
| 6.4% TiO2/FEGDA | 1.498 | 4 | −0.007 | 0.161 | −0.007 | x | 0.210 |
| 8.02% ZrO2 & 10.98% | 1.709 | 5 | −0.217 | −0.049 | −0.217 | −0.210 | x |
| TiO2/MM2 | | | | | | | |
| δn/δλ | | | δn/δλ (col)- δn/δλ (row) | | | | |
| 0% NP/NPGDA | 0.009 | 1 | x | 0.008 | 0.021 | 0.008 | 0.021 |
| 19% ZrO2/MM1 | 0.018 | 2 | −0.008 | x | 0.013 | 0.000 | 0.013 |
| 19% AZO/FEGDA | 0.030 | 3 | −0.008 | −0.013 | x | −0.013 | 0.000 |
| 6.4% TiO2/FEGDA | 0.018 | 4 | −0.008 | 0.000 | 0.013 | x | 0.013 |
| 8.02% ZrO2 & 10.98% | 0.030 | 5 | −0.021 | −0.013 | 0.000 | −0.013 | x |
| TiO2/MM2 | | | | | | | |
| δn(λshort-λc)/δn(λshort- | | | δn(λshort-λc)/δn(λshort-λlong (column) - δn(λshort-λc)/ | | | | |
| λlong) | | | δn(λshort-λlong (row) | | | | |
| 0% NP/NPGDA | 0.630 | 1 | x | 0.064 | 0.003 | 0.090 | 0.084 |
| 19% ZrO2/MM1 | 0.694 | 2 | −0.064 | x | −0.061 | 0.026 | 0.020 |
| 19% AZO/FEGDA | 0.633 | 3 | −0.003 | 0.061 | x | 0.087 | 0.081 |
| 6.4% TiO2/FEGDA | 0.720 | 4 | −0.090 | −0.026 | −0.087 | x | −0.006 |
| 8.02% ZrO2 & 10.98% | 0.714 | 5 | −0.084 | −0.020 | −0.081 | 0.006 | x |
| TiO2/MM1 | | | | | | | |

In these mixes, MM1 is a monomer mix consisting of 40.5% BMA, 16.2% TCMDA, and 24.3% DEGDA, where the volume percentages are references to the total volume. It is possible to create a wide range of high and low RI optical inks with a wide variety of partial dispersion values, and a wide variety of high and low dispersion optical inks with a wide range of partial dispersion values. The dispersive slope of engineered nanomaterials are generally more expensive than acrylate monomers. Thus, a strategic ink composition involves formulating the highest possible RI acrylate base, then adding small amounts of nanoparticles until the desired RI value or refractive index spectrum is reached. Note that as shown in the Table, the ink RI can be altered higher or lower, depending on acrylate and nanoparticle material choices.

Referring now to the drawings, like components are designated by like reference numerals. Methods of manufacture and various embodiments of the present disclosure are described further herein below.

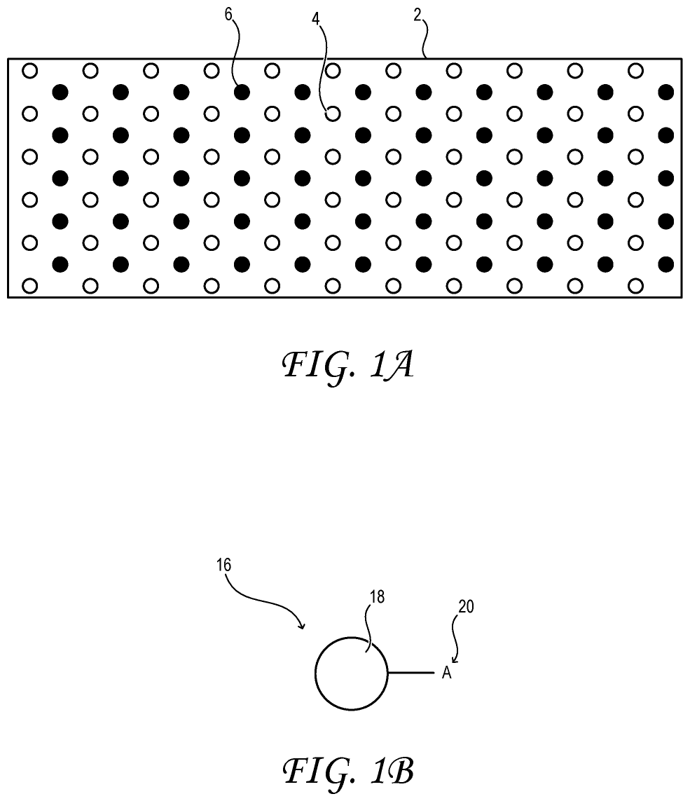

FIG. 1A shows an example schematic diagram of an optical ink matrix 2 of a gradient refractive index (GRIN) lens. The optical ink matrix 2 comprises a UV polymerizable monomer 4 and a multifunctional monomer 6. While the drawings show simple shapes, the monomers may take many different shapes. The UV polymerizable monomer 4 of the optical ink is chosen from a class of vinyl, methacrylate, and urethane. Thus, during polymerization of the UV polymerizable monomer, the resulting polymer may take on different shapes. It is important to note that the UV polymerizable monomer may also be cured alternatively, such as with other types of radiation, or chemically.

A first multifunctional monomer 6 may also be added to an optical ink matrix 2. The spherical shape of the first multifunctional monomer 6 in FIG. 1A is only for diagrammatic purposes and therefore does not have to represent the actual shape of the first multifunctional monomer 6. The first multifunctional monomer 6 may also be polymerized by a source of radiation. More specifically, the first multifunctional monomer 6 may be polymerized by UV radiation. A second multifunctional monomer may further be added to the optical ink matrix 2. The second multifunctional monomer, like the first multifunctional monomer may also be polymerized using UV radiation. The first and second multifunctional monomers may also have different refractive indices. In an example embodiment, on one end of a GRIN lens, one type of monomer is present while on another end of the same GRIN lens, another type of monomer is used thereby giving 2 regions of the same GRIN lens different refractive indices. This allows for refraction of light to be engineered in specific locations within the GRIN lens. Using 3D printing, different refractive indices may be engineered in different locations within the GRIN lens without it being axially symmetric.

FIG. 1B shows an example schematic diagram of a multifunctional monomer 16 comprising a monomer part 18 and a functionalized part 20 represented by the letter A. The multifunctional monomer 16 may take on different shapes and the spherical shape depicted in FIG. 1B is used for diagrammatic purposes. The multifunctional monomer 16, of an optical ink matrix as shown in FIG. 1A, either acting as a first or second multifunctional monomer may take the form as presented in in FIG. 1B. More specifically, the multifunctional monomer may take on the following exemplary form having a low refractive index:

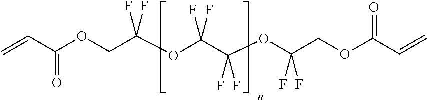

where the structure of molecule has fluorine as the functionalized parts 20 and n is a positive integer. The value of n may be controlled during the synthesis or polymerization process to control the viscosity of the optical ink matrix since the size of the molecule affects the viscosity. The multifunctional monomer may also take on another exemplary form:

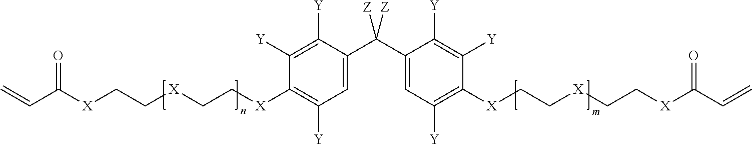

where X is oxygen, sulfur, or nitrogen, Y is hydrogen or a halogen, Z is a hydrogen, a halogen, a phenyl group, or an alkyl group, and m is a positive integer.

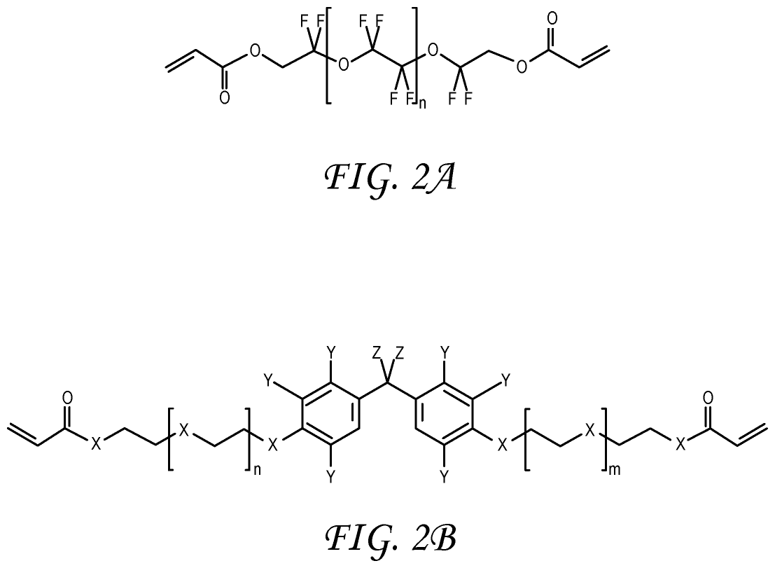

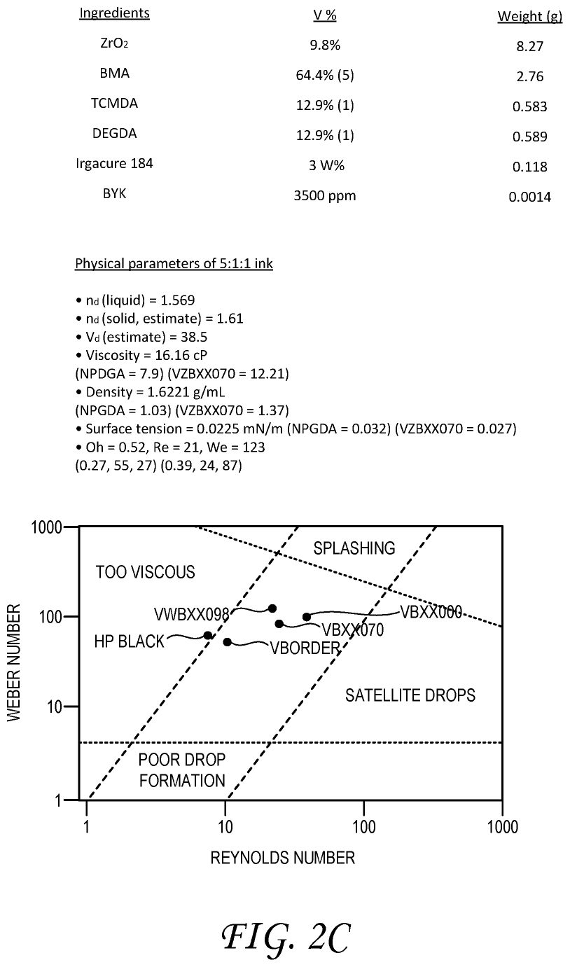

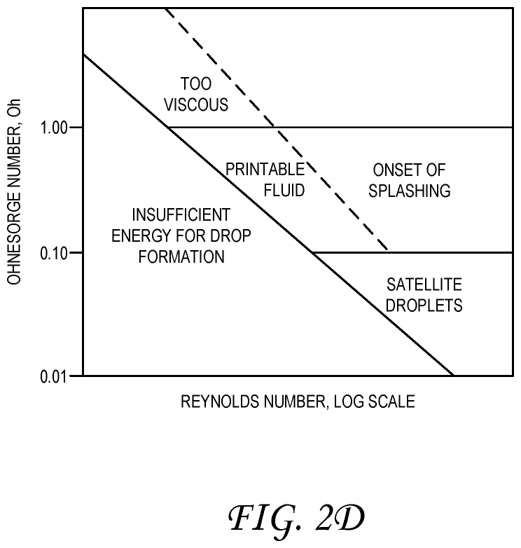

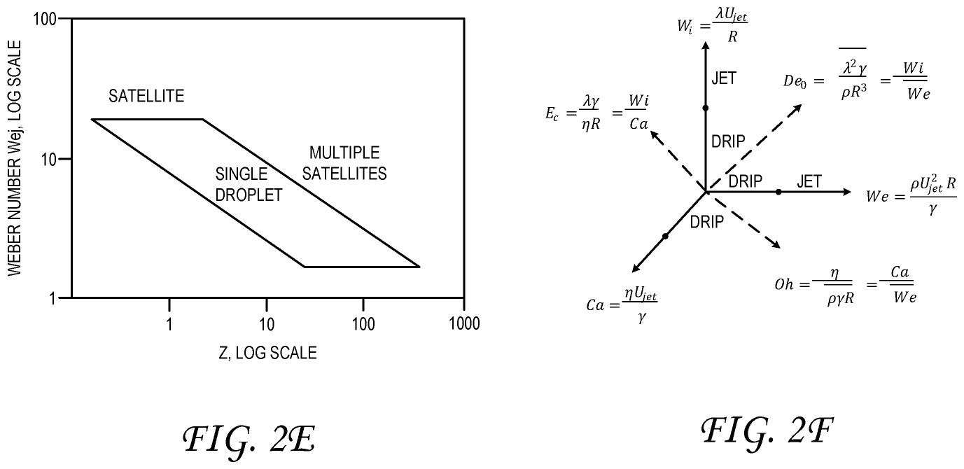

Referring to FIGS. 2A and 2B, these drawings show example multifunctional monomers mentioned in FIGS. 1A-B. In one example embodiment, a chemical composition may comprise a UV polymerizable monomer, a first and second optical ink, wherein each of the first and second optical inks comprises a multifunctional monomer, wherein the multifunctional monomer in the first optical ink has a different chemical structure than the multifunctional monomer in the second optical ink. The different chemical structures between the multifunctional monomers allow for a difference in refractive indices. The multifunctional monomer in FIG. 2A, where the structure of molecule has fluorine as the functionalized parts 20 and n is a positive integer. The value of n may be controlled during the synthesis or polymerization process to control the viscosity of the optical ink matrix since the size of the molecule affects the viscosity. The multifunctional monomer may also take on another exemplary form as seen in FIG. 2B, where X is oxygen, sulfur, or nitrogen, Y is hydrogen or a halogen, Z is a hydrogen, a halogen, a phenyl group, or an alkane, and m is a positive integer. Depending on whether the refractive index is to be raised or lowered, the use of the structures in FIG. 2A or FIG. 2B may be used. The multifunctional monomer as shown in FIG. 2A comprising using monomers containing fluorine may lower the refractive index below that which can be achieved in monomers containing only C, O, and H. The multifunctional monomer as shown in FIG. 2B containing phenyl functionality may raise the refractive index above that which can be achieved by monomers containing only C, O, and H. Additionally, monomers containing hetero atoms chosen from a list of hetero atoms containing sulfur and halogens may raise the refractive index above that which can be achieved by monomers containing only C, O, and H.

One specific embodiment uses a high index ink comprising benzyl acrylate, tricyclo[5.2.1.02,6]decanedimethanol diacrylate (TCMDA), pentaerythritol tetraacrylate (5.4:1:1 vol.) with 1% Irgacure 184 and 202 ppm BYK-UV-3500, having refractive index of 1.52. The low refractive index ink of this embodiment is ((perfluoroethane-1,2-diyl)bis(oxy))bis(2,2-difluoroethane-2,1-diyl) diacrylate with 3% wt. Irgacure 184, having a refractive index of 1.374. In yet another specific embodiment, the monomers may be used in concert with nanoparticles to further engineer the refractive indices of the resulting GRIN lens. For example, for a high refractive index ink, neopentylglycol diacrylate 89% and 11% ZrO₂ nanoparticles (by volume) may be used with 1% Iracure 184 and 250 ppm BYK-UV-3500, having a refractive index of 1.53. A low refractive index ink of for this example may use ((perfluoroethane-1,2-diyl)bis(oxy))bis(2,2-difluoroethane-2,1-diyl) diacrylate with 3% wt. Irgacure 184, having a refractive index of 1.374.

The table in FIG. 2C provides a formulation for a high RI ink in one, non-limiting example. An acrylate mixture with a ratio of 5:1:1 BMA:DEGDA:TCMDA, with added oxide particles, photoinitator, and surfactant yields fully cured transparent polymer. Shown are nominal volume percentages of each constituent, and the resulting properties of the high RI ink. In FIG. 2C, the properties of the inks are shown in a plot of the Weber number and the Reynolds number.

Referring again to FIG. 2C, the areas within the trapezoid are considered to be inkjet printable for the specific printhead used. Other examples of printable BMA:DEGDA:TCMDA based inks, include for example 1:1:1, 3:1:1, and other combinations that allow for jetting by the inkjet printers. Various other dopants can be added to tailor the chromatic properties of the inks by changing the index values as a function of the wavelength. Referring to FIG. 2D, a similar chart can be generated with the Ohnesorge Number plotted against the Reynolds number. For a simple Newtonian fluid where the viscosity is independent of the shear rate and there is no elasticity, the Ohnesorge number can be used to determine a range in which printing is possible. If the Oh number is too large (>1), the fluid is so viscous that there is not sufficient energy to form a jet and that if the Oh number is too small (<01), surface tension will induce satellite drop formation. FIG. 2E, provides a plot of the Weber number against the inverse of the Oh number, which identifies a region where single droplets are preferably formed. FIG. 2F shows a plot of a larger multi-dimensional operating space defined by dimensionless groups for dispersing complex optical inks under different print conditions.

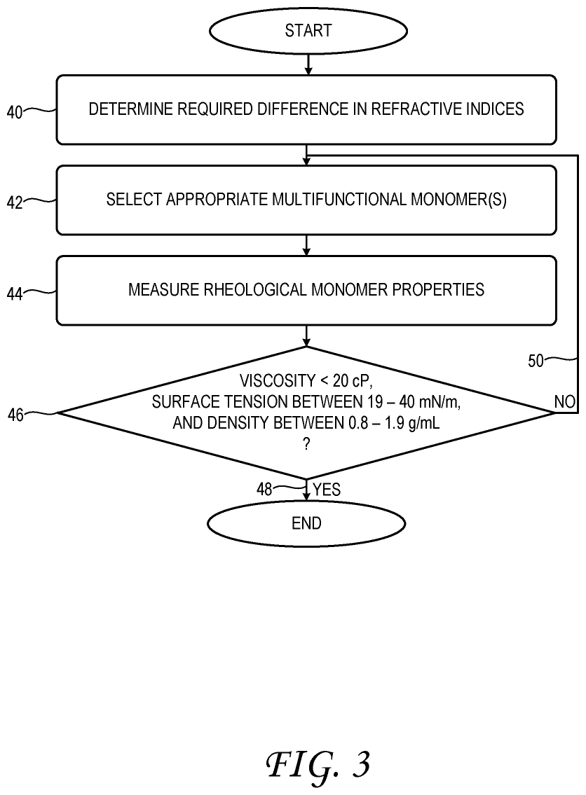

Referring to FIG. 3, this drawing shows a flowchart of an example method of making a GRIN lens. The method in this figure is a method wherein the appropriate multifunctional monomers may be used in an optical ink matrix 2 as shown FIG. 1A, for example. In step 40, a determination in differences in refractive indices is contemplated. A gradient refractive index map may be useful in this step to determine locations which the different multifunctional polymers or nanocomposites may be 3D printed within the optical ink matrix 2 of a GRIN lens. In step 42, appropriate multifunctional monomers or nanocomposites based on multifunctional monomers are selected. The monomer-based inks are selected based on predetermined refractive index differences. In an exemplary embodiment, the ratios of the multifunctional monomers used in this ink may be varied to control rheological properties such that using monomers containing hetero atoms chosen from a list containing chalcogenides and halogens to raise the refractive index above that which can be achieved by monomers containing only C, O, and H. The method further comprises using monomers containing phenyl functionality to raise the refractive index above that which can be achieved by monomers containing only C, O, and H. The method also comprises using monomers containing fluorine to lower the refractive index below that which can be achieved in monomers containing only C, O, and H. The monomers may be selected or configured such that the resulting polymerized material has a crosslink density greater than 1×10⁻⁴ mol/cm³. In step 44, once the optical ink matrix 2 contains all the relevant multifunctional monomers, rheological properties are measured to see if the values of these properties match up with predetermined desired values. In step 46, if the measured viscosity is less than 20 cP, the surface tension is measured to be between 19 and 40 mN/m, and the density is measured to be between 0.8 and 1.9 g/mL, then no further step may be needed as in step 50. However, if all the requirements in step 46 are not met, then a reselection of multifunctional monomers is desired as shown in step 48.

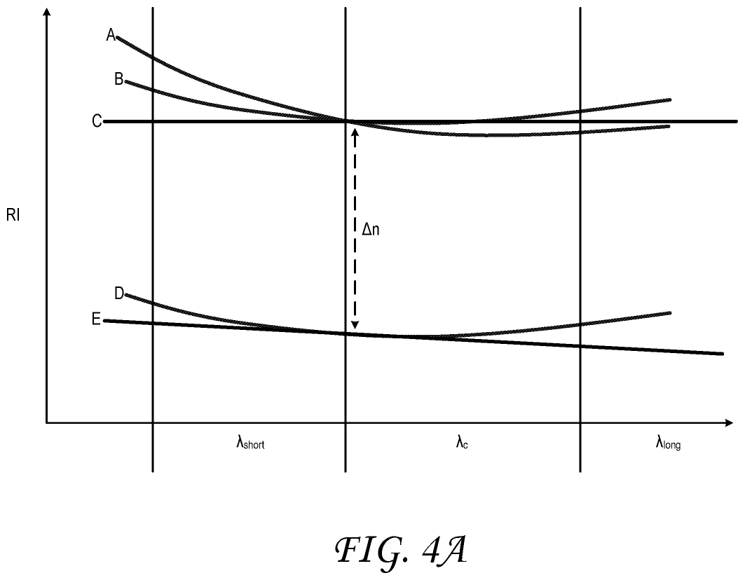

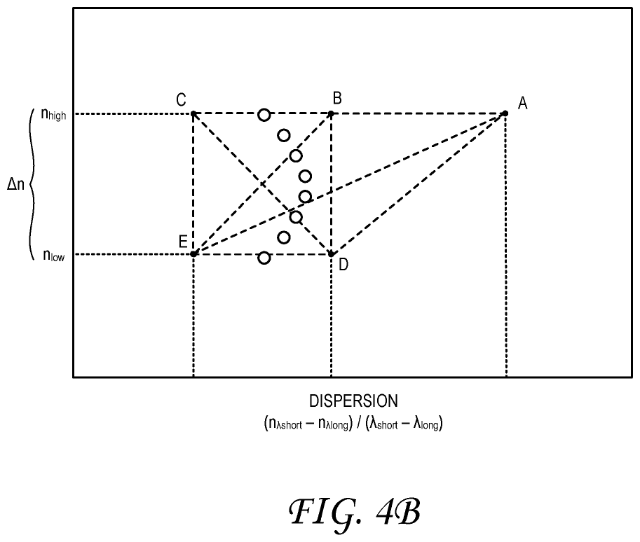

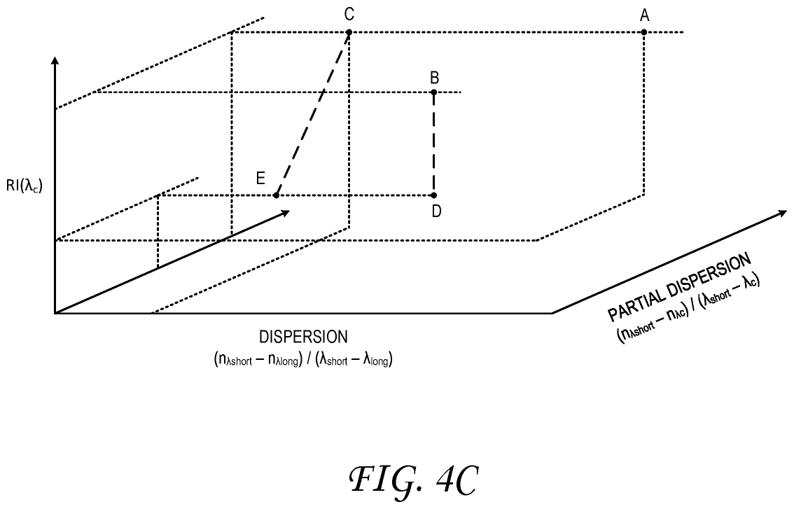

FIG. 4A shows an example of high and low index inks. Each of the inks high refractive index inks has a different slope, as defined by the RI values at the low end of the wavelength band, λshort, and the high index of the wavelength band, λlong. In these exemplary inks, the three high RI inks all share a common reference RI value and the low high RI inks all share a common reference RI value, defined at the center wavelength, λc. An is the same for all high index and low index pairs, i.e. A-D, B-D, C-D, A-E, B-E, C-E). As can be seen, the Δn (λshort) value is higher for ink pair AE than it is for ink pair CE. Similarly, the Δn (λlong) values are greater for ink pairs BE than it is for AD.

FIG. 4B shows the RI values for the various inks plotted against their dispersion values, as defined by RI(λshort)−RI(λlong). For these exemplary inks, the ink pair CE has the same slope as the ink pair BE. Although the slopes are different for each ink pair, because Δn(λshort)=Δn(λlong), the optical power is the same at the λshort and λlong wavelengths. For plano-plano optical devices, this allows for the devices to be achromatic. FIG. 4B shows the reference index of the optical inks plotted against the dispersive slope of the refractive index slope. The plot also shows gradients created by mixing binary nik pairs. The gradients shown in the dashed lines are binary mixes that vary from 100%/0% mixes of the inks (100% one ink) to 0%/100% (100% of the other ink) mixes of the inks. The dashed line represent intermediate mixes, wherein the volumetric percentage of the constituent inks equals 100%. The gradients formed by ink pairs CE, CD, BE, BD, AE, and AD all have a same Δn. However, ink pairs that have a lower dispersive slope at λshort than the dispersive slope at λlong, such as ink pairs CD, have a larger power(Δn) at λlong than at λshort. For the ink pairs that have a greater dispersive slope at λshort than the dispersive slope at λlong, such as ink pair BE<the Δn is greater at λshort than the dispersive slope at λlong.

For ink pairs CB, BA, CA, and ED, the index is the same, there is no optical power at λc (e.g. Δn=0) and the optical devices disperse light differently as a function of wavelength. The gradient profile represented by the stars represents photocomposed gradients that may only by created by mixing three or more inks. In the case of this notional gradient, the highest index in the gradient must be created by a mix of inks C and B, or a mix of inks C and A, whereby the mix of inks C and B would have a mix ratio closer to 1. As the composition of the gradient decreases in index value, at minimum the mix requires inks C,B,E, inks C,B,D, inks C,A,E, or inks C,A,D. The gradient continues until it terminates in a binary mix of ink pair ED. Thus, the entire of the gradient requires a set of inks ECBD or CEAD to be created. More balanced mixing of the inks is achieved with mix ECBD.

FIG. 4C shows the RI of the inks plotted against the dispersion, and the partial dispersion values in a three-axis representation. Gradients CE and BD are shown for reference. These gradients both have gradients that are perpendicular, so that the index values have the same dispersion value, however whereas ink pair BD, also has a common partial dispersion value, the inks of pair CE have different partial dispersion values. The volumetric region bounded by the points A,B,C,D, and E represent the solution space, from which gradients may be created within the optical device. Similarly, for operation in the radio-frequency (RF) portion of the spectrum, the refractive index may be changed by using high permittivity nanoparticle additives, such as BaTiO₃ or carbonaceous nanoparticles, with low loss monomers. For portions of the electro-magnetic spectrum, the refractive index may also be tailored using ferromagnetic, ferrite, hexaferrite, or higher high permeability nanoparticle. GRIN devices may be made using printing to grade the index of these materials, including incorporating air as one of the materials of the composition.

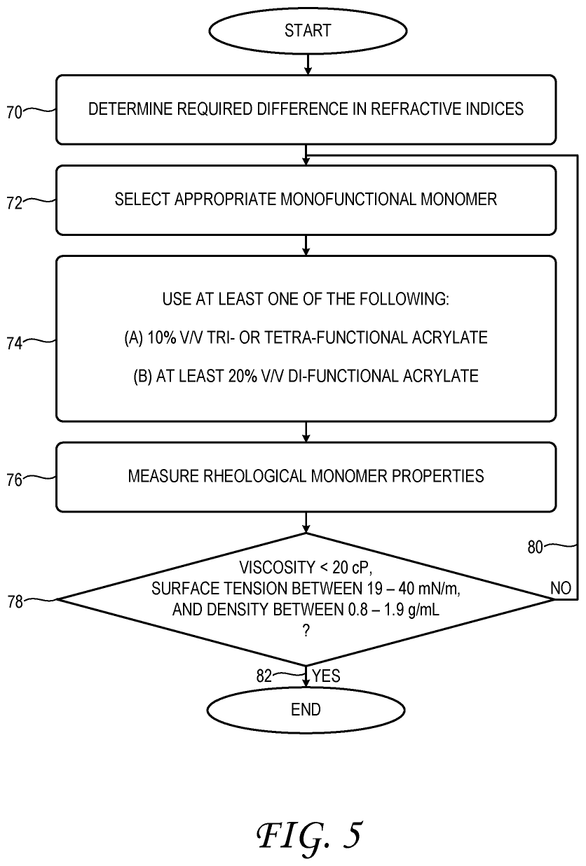

FIG. 5 shows a flowchart of an example method of making a GRIN lens. The method in this figure is yet another example method. However, a mono-functional monomer may be used in an optical ink matrix 2 as shown FIG. 1A, for example. In step 70, a determination in differences in refractive indices is contemplated. A gradient refractive index map may be useful in this step to determine locations which the different multifunctional polymers may be 3D printed within the optical ink matrix 2 of a GRIN lens. In step 72, an appropriate mono-functional monomer is selected. Monomers are selected based on predetermined refractive index differences. In this method, since a monofunctional monomer is selected, at least one other multifunctional monomer is also selected. In step 74, either 10% v/v tri- or tetra-functional acrylate or at least 20% v/v di-functional acrylate is used in addition to a mono-functional monomer used in step 72. In step 76, once the optical ink matrix 2 contains all the relevant mono-functional and multifunctional monomer, rheological properties are measured to see if the values of these properties match up with predetermined desired values. In step 78, if the measured viscosity is less than 20 cP, the surface tension is measured to be between 19 and 40 mN/m, and the density is measured to be between 0.8 and 1.9 g/mL, then no further step may be needed as shown in step 82. However, if all the requirements in step 46 are not met, then a reselection process as in step 80 may be used.

In addition to disclosed compositions and methods of freeform, radial, or non-axially symmetric GRIN lens, the present disclosure may use diffusion-controlled GRIN fabrication using monomers alone (rather than varying the amount of nanoparticles in a composite material) to achieve greater lens power by increasing the difference in refractive index between high/low index inks and improved optical quality by allowing smaller feature sizes and improving the speed of diffusion and therefore the rate at which GRIN optical components may be fabricated as diffusion time is the limiting bottle-neck in 3D printing of GRIN. However, an example embodiment may also include the use of nanoparticles to further engineer the optical features of the GRIN lens. The formulation of the high refractive index ink in this disclosure may help with compatibility with some monomers including a fluorinated monomer, such as FEGDA, further improving inkjet printability modifying formulations of GRIN ink in order to improve the compatibility of ink pairs while maintaining desired rheological properties for inkjet printing.

From this description one skilled in the art can manufacture the apparatus and practice the methods in accordance with the present disclosure. Those skilled in the art will recognize that while above-described embodiments and method of manufacture are exemplified using particular materials, others may be combined using these embodiments without departing from the spirit and scope of this disclosure. Although some of the embodiments explained above have certain symmetry, one skilled in the art will recognize that such symmetry is not a requirement.

The subject matter of the present disclosure includes all novel and nonobvious combinations and subcombinations of the various processes, systems and configurations, and other features, functions, acts, and/or properties disclosed herein, as well as any and all equivalents thereof.

1. A curable, optical ink comprising:
a first monomer photopolymerizable over a first wavelength band; and
a multifunctional second monomer photopolymerizable over a second wavelength band distinct from the first wavelength band.

2. The ink of claim 1 wherein the first wavelength band is an infrared band.

3. The ink of claim 1 wherein the second wavelength band is an infrared band.

4. The ink of claim 1 wherein the first or second wavelength band is an ultraviolet band.

5. The ink of claim 1 further comprising a multifunctional third monomer.

6. The ink of claim 5 wherein the second and third monomers have different refractive indices.

7. The ink of claim 1 wherein the second monomer comprises: 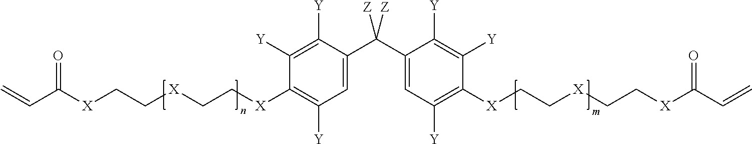
where X═O, S, or NH; Y═H or a halogen; Z═H, a halogen, phenyl, or alkyl group; and m and n are integers greater than zero.

8. The ink of claim 1 wherein the second monomer comprises: 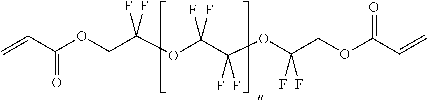
where n is an integer greater than zero.

9. The ink of claim 1 wherein the first monomer includes a monoacrylate.

10. The ink of claim 1 wherein the first monomer includes benzyl acrylate (BA), benzyl methacrylate (BMA), 2-(phenylthio)ethyl acrylate (2-PTEA), or benzenethiol methacrylate (BTM).

11. The ink matrix of claim 1 further comprising a loading nanoparticles.

12. A method of manufacture of a gradient refractive-index (GRIN) optical device via 3D printing, the method comprising:
determining a target difference in refractive index spectra for two or more different inks to be used to manufacture the optical device;
determining desired rheological properties of the two or more different inks;
selecting two or more multifunctional monomers for the two or more different inks based on the target difference;
determining whether additives are required in the two or more different inks in order to achieve the target difference;
optimizing deposition and curing of the two or more different inks based on printing and rheological properties of the two or more different inks with the additives required; and
printing the optical device.

13. The method of claim 12, where cured-polymer nanoparticle additives, comprising one or more selected monomers, are dispersed within a given ink so that the nanoparticle loading densities and uncured-monomer contents of the two or more different inks are convergent.

14. The method of claim 12, further comprising measuring properties of the optical device and adjusting the deposition and curing to optimize the method.

15. The method of claim 12, wherein a pattern of depositing a droplet of a given ink is determined, at least in part, by rheological properties of the two or more different inks.

16. The method of claim 12, wherein the two or more different inks are deposited in patterns based on an error diffusion algorithm, performed using kernels that span two or more dimensions of the optical device, and defined, at least in part, by the rheological properties of the two or more different inks.

17. The method of claim 12, wherein the two or more different inks include three or more inks deposited in different densities and caused to interdiffuse, such that within the optical device there exist two or more gradient index profiles with respect to dispersion or partial dispersion.

18. The method of claim 12, wherein the two or more different inks include three or more inks deposited in different densities and caused to interdiffuse, such that within the optical device there exist two or more gradient index profiles with respect to dispersion, and after fabrication a surface of the optical device is shaped in proportion to at least one of the gradient index profiles.
